(19) United States
(12) Patent Application Publication
(10) Pub. No.: US 2006/0222004 A1
(43) Pub. Date: Oct. 5, 2006

(54) Methods and apparatus for transferring data

(75) Inventors: Bruce L. Beukema, Hayfield, MN (US); Lance G. Hehenberger, Byron, MN (US); Nathaniel P. Sellin, Rochester, MN (US); Robert A. Shearer, Rochester, MN (US); Bruce M. Walk, Rochester, MN (US)

Correspondence Address: IBM Corporation;Intellectual Property Law, Dept. 917, 3605 Highway 52 North, Rochester, MN, 55901, US

(73) Assignee: International Business Machines Corporation, Armonk, NY (US)

(21) Appl. No.: 11/097,735

(22) Filed: Apr. 1, 2005

(51) Int. Cl. H04L 12/28

(52) U.S. Cl. 370/466; 370/392

(57) ABSTRACT

In a first aspect, a first method is provided for transferring data using an Infiniband (IB) protocol. The first method includes the steps of (1) receiving a non-IB packet having header data and payload data at a first node of a computer system; and (2) modifying data in the non-IB packet to convert the non-IB packet to an IB packet having header data and payload data. The header data of the non-IB packet is not included in the payload data of the IB packet resulting from the conversion. Numerous other aspects are provided.

### FIELD OF THE INVENTION

The present invention relates generally to computer systems, and more particularly to methods and apparatus for transferring data.

### BACKGROUND

Nodes of an existing computer system may employ one or more legacy protocols (e.g., protocols which are older than current protocols) to put data into packets and transfer such packets between nodes. Because such legacy protocols may be less efficient than current protocols such as Infiniband, the effective rate at which the legacy protocols (e.g., non-Infiniband protocols) transfer data may be much slower than current protocols. However, converting an entire computer system to employ a current protocol may require significant hardware redesign which may be cost prohibitive. Further, due to the prevalence of legacy protocols in existing computer systems, converting such systems to a current protocol, thereby abandoning the legacy protocol, may not be feasible. Accordingly, improved methods and apparatus for transferring data are desired.

### SUMMARY OF THE INVENTION

In a first aspect of the invention, a first method is provided for transferring data using an Infiniband (IB) protocol. The first method includes the steps of (1) receiving a non-IB packet having header data and payload data at a first node of a computer system; and (2) modifying data in the non-IB packet to convert the non-IB packet to an IB packet having header data and payload data. The header data of the non-IB packet is not included in the payload data of the IB packet resulting from the conversion.

In a second aspect of the invention, a first apparatus is provided for transferring data using an IB protocol. The first apparatus includes a first computer system node having (1) IB logic adapted to execute IB software and transfer data as IB packets; and (2) first logic coupled to the IB logic. The first logic is adapted to (a) receive a first non-IB packet having header data and payload data from the non-IB logic; and (b) modify data in the first non-IB packet to convert the first non-IB packet to an IB packet having header data and payload data. The header data of the first non-IB packet is not included in the payload data of the IB packet resulting from the conversion.

In a third aspect of the invention, a first system is provided for transferring data using an IB protocol. The first system includes (1) a first computer system node having (a) IB logic adapted to execute IB software and transfer data as IB packets; and (b) first logic, coupled to the IB logic, and adapted to (i) receive a non-IB packet having header data and payload data from the non-IB logic; and (ii) modify data in the non-IB packet to convert the non-IB packet to an IB packet having header data and payload data. The header data of the non-IB packet is not included in the payload data of the IB packet resulting from the conversion. The first system also includes (2) a second computer system node; and (3) an IB network coupling the first computer system node to the second computer system node.

In a fourth aspect of the invention, a first computer program product is provided. The computer program product includes a medium readable by a computer having computer program code adapted to (1) receive a non-IB packet having header data and payload data at a first node of a computer system; and (2) modify data in the non-IB packet to convert the non-IB packet to an IB packet having header data and payload data, wherein header data of the non-IB packet is not included in the payload data of the IB packet resulting from the conversion. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE FIGURES

FIG. 1 is a block diagram of a system for transferring data in accordance with an embodiment of the present invention.

FIG. 2 is a schematic representation of data flow in the system for transferring data in accordance with an embodiment of the present invention.

FIG. 3 is a block diagram of an example structure of a data packet assembled using a non-Infiniband protocol.

FIG. 4 is a block diagram of the structure of an exemplary data packet assembled using the Infiniband protocol.

FIG. 5 is a block diagram of the structure of a non-Infiniband protocol data packet converted to an Infiniband protocol data packet in accordance with an embodiment of the present invention.

FIG. 6 illustrates an exemplary method of transferring data in accordance with an embodiment of the present invention.

### DETAILED DESCRIPTION

The present invention provides methods and apparatus for converting a data packet of a non-IB protocol (“non-IB packet”) to a data packet of an IB protocol (“IB packet”), and vice versa. Rather than encapsulating the non-IB packet in an IB packet, the present invention may convert a non-IB packet to an IB packet, using the data in non-IB packet header fields to modify fields of IB packet header data. In this manner, payload data of the resulting IB packet is not required to store redundant header data associated with the original non-IB packet as would be required in encapsulation.

Existing computer systems may include a plurality of nodes coupled via a network. Each node may employ a non-IB protocol to combine data into non-IB packets and/or receive data combined into non-IB packets. Such packets may be transmitted from a source node to a destination node of an existing computer system using the non-IB protocol. However, existing systems do not transmit non-IB packets between such nodes using IB protocol.

The present invention provides methods and apparatus for transmitting non-IB packets from a source node (e.g., to a destination node) of a computer system using IB protocol. The source and destination nodes may support both the non-IB and IB protocols. For example, the source node may include first logic adapted to modify data, which was previously combined into a non-IB packet (or received as a non-IB packet), to data combined into an IB packet (e.g., an IB Unreliable Datagram). More specifically, the first logic may update header data of the non-IB packet into corresponding header data of the IB packet. Because the first logic may employ existing IB packet header data fields to store the updated non-IB packet header data, the present methods may reduce and/or minimize to size of the IB packet resulting from the conversion. Consequently, the present methods and apparatus may efficiently utilize bandwidth while transmitting such IB packets.

Thereafter, the IB packet resulting from the conversion may be transmitted to the destination node using the IB protocol. The destination node may include second logic adapted to modify the received IB packet into a non-IB packet. In this manner, non-IB data packets may be transmitted between the source and destination node of a computer system using IB protocol. Thereafter, the destination node may process the non-IB packet and/or forward the non-IB packet to another node.

To convert a non-IB packet into an IB packet, much of the header data fields of the non-IB packet is not modified but rather copied into corresponding header data fields of the IB packet by the first logic. Similarly, to convert an IB packet (e.g., resulting from a previous conversion of a non-IB packet) into a non-IB packet, much of the header data fields of the IB packet is not modified but rather copied into corresponding header data fields of the non-IB packet by the second logic. In this manner, any latency introduced by such conversion may be reduced.

In some embodiments, the source node may include the second logic and/or the destination node may include the first logic. Consequently, non-IB packets may be transmitted between such nodes (e.g., in either direction) using IB protocol. Further, in such embodiments the first and second logic may be integrated.

Through use of the present methods and apparatus, a data packet may be converted from a non-IB packet to an IB packet at a source node and transmitted to a destination node using IB protocol. Further, the data packet may be converted from an IB packet to a non-IB packet at the destination node.

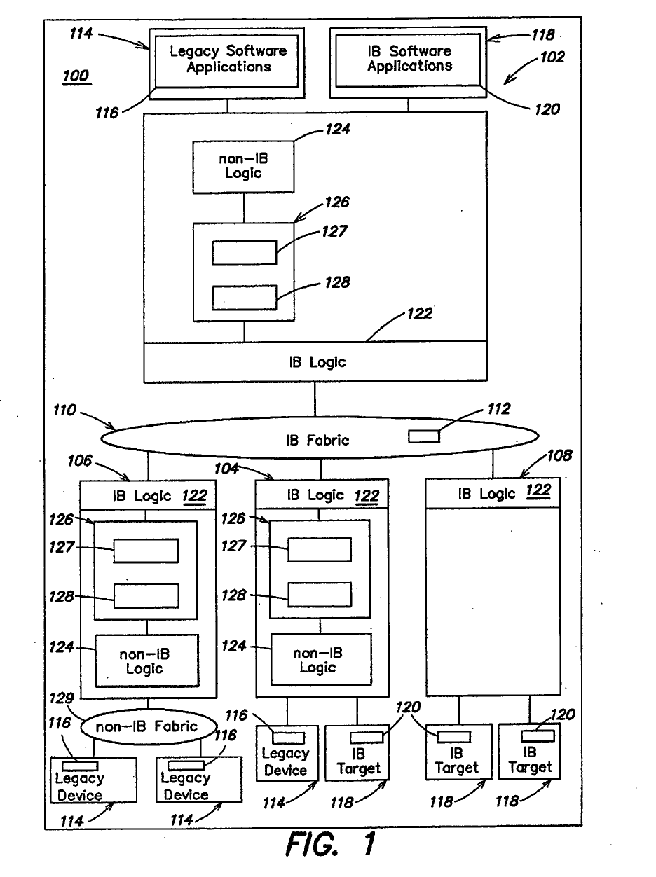

FIG. 1 is a block diagram of a system for transferring data in accordance with an embodiment of the present invention. With reference to FIG. 1, a computer system 100 may include a plurality of nodes 102-108. Each node 102-108 may be a processing, storage and/or network device. The computer system 100 may employ a current protocol, such as Infiniband (Infiniband Architecture Specification). For example, a first through fourth node 102-108 of the computer system 100 may be coupled via a network 112 employing an IB protocol (e.g., an IB fabric). The IB network 110 may include a plurality of switches 112 (only one shown) or similar network devices. According to the present invention, one or more nodes 102-108 of the computer system 100 may support non-IB (e.g., legacy) software and/or logic but transmit data to another node 102-108 of the computer system 100 using the IB network 110. In this manner, the present methods and apparatus may update legacy computer systems to employ current (e.g., faster) data transmission technology, such as the IB protocol and a network employing such protocol, without requiring a significant and costly hardware redesign. Consequently, legacy logic and software may function with little or no changes alongside IB logic and software.

For example, the first node 102 of the computer system 100 may include one or more devices 114 (hereinafter “non-IB devices 114”) adapted to execute non-IB software applications 116, such as legacy software applications. Similarly, the first computer system node 102 may include one or more devices 118 (hereinafter “IB devices 118”) adapted to execute IB software applications 120. The first computer system node 102 may include logic 122 (hereinafter “IB logic 122”) coupled to and/or included in an IB device 118 which is adapted to combine received data into an IB packet for transmission via the IB network 110 and/or separate an IB packet received from the IB network 110 into data for the IB device 118. The IB devices 118 and/or IB logic 122 may be included in an IO chip, and therefore, IB protocol may be implemented in the chip. Similarly, the first computer system node 102 may include logic 124 (hereinafter “non-IB logic 124”) coupled to and/or included in a non-IB device 114 which is adapted to combine data received from the non-IB device 114 into a non-IB packet and/or separate a received non-IB packet into data. Further, the non-IB logic 122 may receive a non-IB packet. For example, the non-IB device 114 may employ the Remote Input Output (RIO) protocol (RIO Architecture Specification), developed by the assignee of the present invention, IBM Corporation of Armonk, N.Y. However, the non-IB devices 114 and non-IB software applications may employ or relate to a different non-IB protocol.

Further, the non-IB logic 124 may be coupled to conversion logic 126 adapted to convert a non-IB packet to one or more portions of an IB packet and/or vice versa. For example, the conversion logic 126 may include first logic 127 adapted to receive a non-IB packet output from the non-IB logic 124 and convert such packet to one or more portions of an IB packet similar to that output from the IB device 118. Additionally or alternatively, the conversion logic 126 may include second logic 128 adapted to receive an IB packet (e.g., which was previously converted from a non-IB packet to the received IB packet) via the IB network 110 and convert such packet to a non-IB packet. The non-IB logic 124 may be the same as or similar to existing non-IB logic. For example, the non-IB logic 124 may be existing non-IB logic adapted to combine data received from a non-IB device into a non-IB data packet and/or receive a non-IB data packet which has been modified to couple to the first and/or second logic 127, 128.

Similar to the IB device 118, the conversion logic 126 may be coupled to the IB logic 122. The IB logic 122 may be further adapted to combine data received from the conversion logic 126 into an IB packet for transmission via the IB network 110 and/or separate an IB packet received via the IB network 110 into data for the conversion logic 126. In this manner, the IB logic 122 may receive and/or transmit IB packets via the IB network 110.

The second node 104 of the computer system 100 may be configured and/or function the same as or similar to the first computer system node 102. For example, during some communication, the first computer system node 102 may serve as a data source and the second computer system node 104 may serve as a data destination. Therefore, the first computer system node 102 may transmit an IB packet via the IB network 110, and the second computer system node 104 may receive the IB packet via the IB network 110.

The third computer system node 106 may be similar to the first and second computer system nodes 102, 104. However, in contrast to the first and second computer system nodes 102, 104, the third computer system node 106 may not include one or more IB devices 118. Further, one or more non-IB devices 114 of the third computer system node 106 may be coupled to the conversion logic 126 and/or non-IB logic 124 via a non-IB network (e.g., a non-IB fabric) 129.

In this manner, each of the first through third computer system nodes 102, 104, 106 may be adapted to receive a non-IB packet (e.g., based on data output by a non-IB device 114 of the node 102, 104, 106), convert the non-IB packet to one or more portions of an IB packet, and transmit the resulting IB packet via the IB network 110, and/or to receive an IB packet via the IB network 110, convert the IB packet to a non-IB packet and transmit the resulting non-IB packet (e.g., to a non-IB device 114 of the node 102, 104, 106). Although the conversion logic 126 includes both the first and second logic 127, 128, in some embodiments, the conversion logic 126 may include the first logic 127 or second logic 128. For example, if a node 102, 104, 106 is adapted to only receive a non-IB packet (e.g., based on data output by a non-IB device 114 of the node 102, 104, 106), convert the non-IB packet to one or more portions of an IB packet, and transmit the resulting IB packet via the IB network 110, the conversion logic 126 may include the first logic 127. Alternatively, if a node 102, 104, 106 is adapted to receive an IB packet via the IB network 110, convert the IB packet to a non-IB packet and transmit the resulting non-IB packet (e.g., to a non-IB device 114 of the node 102, 104, 106), the conversion logic 126 may include the second logic 128.

Additionally, in some embodiments, the computer system 100 may include a fourth computer system node 108 including one or more IB-devices 118 adapted to execute IB software applications 120, and IB logic 122 coupled to and/or included in an IB device 118 which is adapted to combine received data into an IB packet for transmission via the IB network 110 and/or separate an IB packet received from the IB network 110 into data for the IB device 118 as described above. In this manner, the fourth computer system node 108 may communicate with remaining nodes (e.g., the first and second computer system nodes 102, 104) of the computer system 100 that include IB devices 118.

The computer system 100 described above is exemplary, and therefore, different computer system configurations may be employed. For example, one or more of the first through fourth computer system nodes 102-108 may be configured in a different manner.

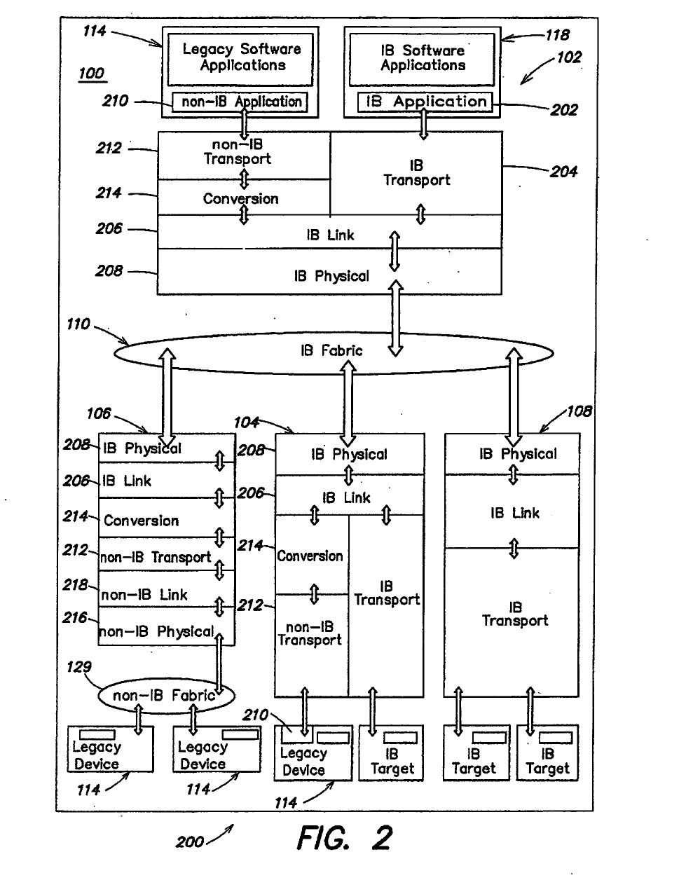

FIG. 2 is a schematic representation 200 of data flow in the system 100 for transferring data in accordance with an embodiment of the present invention. With reference to FIG. 2, during operation, data may be transferred among the nodes 102-108 of the computer system 100. As data is transferred to a node 102-108 or as data is transferred from the node 102-108, the data may be passed (e.g., travel) through layers of functions. Such layers of functions may be defined, in part, by the specification of the protocol (e.g., IB, a non-IB protocol such as RIO, etc.) employed by the node 102-108, and therefore, are not discussed in detail herein.

To transfer data from the first computer system node 102, data may be passed down the layers of function. As stated the first computer system node 102 employs the IB-protocol and a non-IB protocol. Therefore, to transfer data from an IB device 118 of the first computer system node 102, data may be passed from an IB application layer 202 to an IB transport layer 204. From the IB transport layer 204, data may be passed to an IB link layer 206. From the IB link layer 206, data may be passed through the IB physical layer 208, from which data may be transmitted from the node 102 via the IB network 110. To transfer data from a non-IB device 114 of the first computer system node 102, data may be passed from a non-IB application layer 210 to a non-IB transport layer 212. In conventional systems, to transfer data from a node, data may be passed from the non-IB transport layer to a non-IB link layer, and from the non-IB link layer to a non-IB network. However, in contrast, the present methods and apparatus may employ an IB network to transfer non-IB data about the computer system 100. Therefore, from the non-IB transport layer 212, data is passed to a conversion layer 214. As the data is passed down through the conversion layer 214, the data may be similar to data that is passed down through the IB transport layer 204. More specifically, the conversion logic 126 may receive data that has been passed through the non-IB transport layer 212 from the non-IB logic 124 and convert such data to data similar to that which is passed through an IB transport layer 204. Therefore, data may be passed through the conversion layer 214 as the data is processed by the conversion logic 126 (e.g., first logic 127 of the conversion logic 126). Although the conversion logic 126 receives data that is output by a non-IB device 114 of the first computer system node 102, the conversion logic 126 may receive a non-IB packet which was received by the first computer system node 102. From the conversion layer 214, data may be passed through the IB link layer, and from the IB link layer 206, data may be passed through the IB physical layer 208, from which data may be transmitted via the IB network 110. In this manner, according to the present methods and apparatus data that has been passed through two different transport layers (e.g., an IB transport layer 204 and a non-IB transport layer 212), respectively, may be passed through (e.g., merge in) the same IB link layer 206, and thereafter, the same IB physical layer 208.

In a similar manner, data may be passed to the first computer system node 102. For example, data received in the first computer system node 102 from the IB network 110 for an IB device 118 may be passed up through the IB physical layer 208 and IB link layer 206. Thereafter, the data may be passed to the IB transport layer 204 from which the data is transferred to the IB application layer 202. Similarly, data received in the first computer system node 102 from the IB network 110 for a non-IB device 114 may be passed up through the IB physical layer 208 and IB link layer 206. However, thereafter, the data may be passed up to the conversion layer 214. As the data is passed up through the conversion layer 214, the data may be similar to data that is passed up through the IB transport layer 204. The conversion logic 126 may receive the data that has been passed up through the IB link layer 206 from the IB network 110 and convert such data to data similar to data that is passed through a non-IB transport layer 212. Therefore, data may be passed up through the conversion layer 214 as the data is processed by the conversion logic 126 (e.g., second logic 127 of the conversion logic 126). From the conversion layer 214, data may be passed up through the non-IB transport layer 212, from which data may be passed to the non-IB application layer 210. In this manner, data received in the first computer system node 102 from the IB network 110 may be transferred to a non-IB device 114 of the first computer system node 102. Alternatively, after conversion the non-IB data may be forwarded elsewhere.

In a similar manner, data may be passed to and from the second computer system node 104. Consequently, non-IB data may be transferred from a non-IB device 114 of the first computer system node 102 to a non-IB device 114 of the second computer system node 104 via the IB network 110. More specifically, data may be passed down the non-IB application layer 210, non-IB transport layer 212, conversion layer 214, IB link layer 206 and IB physical layer 208 of the first computer system node 102 to the IB network 110. Thereafter, the data may be transmitted to the second computer system node 104. At the second computer system node 104, the data may be passed from IB network 110 up the IB physical layer 208, IB link layer 206, conversion layer 214, non-IB transport layer 212, and non-IB application layer 210 to the non-IB device 114 of the second computer system node 104.

Because the configuration of the third computer system node 106 differs from the first and second computer system nodes 102, 104, data flow to and from the third computer system node 106 may be different than the data flow in the first and/or second computer system node 102, 104. For example, to transfer data from a non-IB device 114 of the third computer system node 106, data may be passed down non-IB layers of functions (not shown) to the non-IB network 129. The non-IB network 129 may transmit the data to non-IB logic 124 of the third computer system node 106. While processed by the non-IB logic 124, the data may be passed up through a non-IB physical layer 216 and non-IB link layer 218 to a non-IB transport layer 212. As stated, the present methods and apparatus may employ an IB network 110 to transfer data about the computer system 100. Therefore, similar to the first and second computer system nodes 102, 104, in the third computer system node 106, from the non-IB transport layer 212, data may be passed to a conversion layer 214. As the data is passed down through the conversion layer 214, the data may be similar to data that is passed down through an IB transport layer 204. More specifically, the conversion layer 214 may receive data that has been passed through the non-IB transport layer 212 from the non-IB logic 114 and convert such data to data similar to that which is passed through an IB transport layer 204. Data may be passed through the conversion layer 214 as the data is processed by the conversion logic 126 (e.g., first logic 127 of the conversion logic 126). From the conversion layer 214, data may be passed down through the IB link layer 206, and from the IB link layer 206, data may be passed down through the IB physical layer 208, from which data may be transmitted from the third computer system node 106 via the IB network 110.

In a similar manner, data may be passed to the third computer system node 106. For example, data received in the third computer system node 106 from the IB network 110 for a non-IB device 114 may be passed up through the IB physical layer 208 and IB link layer 206. Thereafter, the data may be passed up to the conversion layer 214. As the data is passed up through the conversion layer 214, the data may be similar to data that is passed up through an IB transport layer 204. More specifically, the conversion layer 214 may receive data that has been passed up through the IB link layer 206 (e.g., while in the IB logic 122) from the IB network 110 and convert such data to data similar to that which is passed through a non-IB transport layer 212. Data may be passed up through the conversion layer 214 as the data is processed by the conversion logic 126 (e.g., second logic 127 of the conversion logic 126). From the conversion layer 214, data may be passed up to the non-IB transport layer 212. However, from the non-IB transport layer 212, the data may be passed down to the non-IB link layer 218 and non-IB physical layer 216. From the non-IB physical layer 216, the data may be transferred to the non-IB device 114 via the non-IB network 129. At the non-IB device 114 such data may be passed up through non-IB layers of function (not shown). In this manner, data received in the third computer system node 106 from the IB network 110 may be transferred to a non-IB device 114 of the third computer system node 106. It should be noted that because the third computer system node 106 does not include an IB device 118, the IB link layer 206 may not receive data that has been passed through an IB transport layer 204.

The flow of data to and from the fourth computer system node 108 is similar to the flow of data to an IB device 118 and from an IB device 118, respectively, of the first and second computer system nodes 102, 104. Consequently, data flow in the fourth computer system node 108 is not described in detail herein.

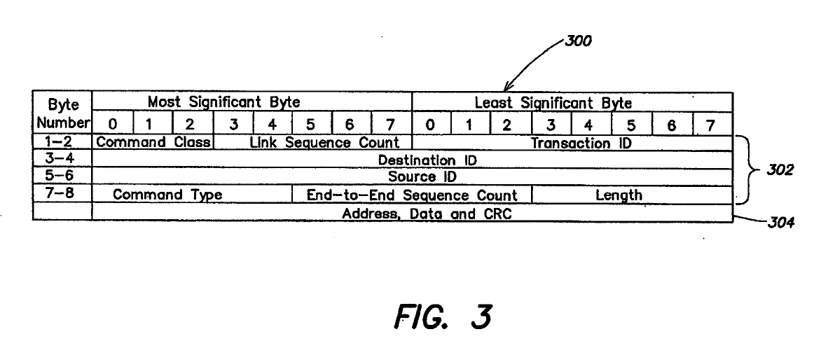

FIG. 3 is a block diagram of an example structure of a data packet assembled using a non-IB protocol. With reference to FIG. 3, a data packet 300 assembled using a non-IB (e.g., legacy) protocol such as RIO (hereinafter “non-IB packet”) may include header data 302 and payload data 304. The header data 302 may be eight bytes in size (although a larger or smaller size may be employed). As shown the header data 302 may include a plurality of data. For example, the header data 302 may include command class data, link sequence count data, transaction ID data, destination ID data, source ID data, command type data, end-to-end sequence count data and length data. The above-described data is exemplary, and therefore, the header data 300 may include a larger or smaller amount and/or different data.

Command class data may describe the function of the packet 300. For example, command class data may identify a packet 300 as a read or write request. The link sequence count data may be employed as the packet 300 is passed through a non-IB link layer 218, and therefore, the link sequence count data is relevant between the non-IB link layer 218 and legacy device 114. The link sequence count data may be used to maintain packet ordering on the non-IB fabric 129. Transaction ID data may associate a response to a request to the request. The transaction ID data may be employed as data passes through a non-IB application layer 210. Destination ID data and Source ID data may provide information about the destination and source, respectively, of the data packet 300. Command type data may modify the command class data. For example, if the command class data identifies the data packet 300 as a write request, the command type data may provide information about the type of write request. End-to-end sequence count may be employed to ensure the packet 300 is transmitted properly to the packet destination. Length data may specify an amount of data to be written or read. Command class data and command type data may serve to identify a manufacturer specific opcode (MSO) of the packet. The MSO associated with a packet may assist a node 102-108 to route the packet.

Further, the non-IB packet 300 may include payload data 304. Payload data 304 may include address data, the essential data to be transmitted to the packet destination and/or error checking data (e.g., cyclic redundancy check (CRC) data).

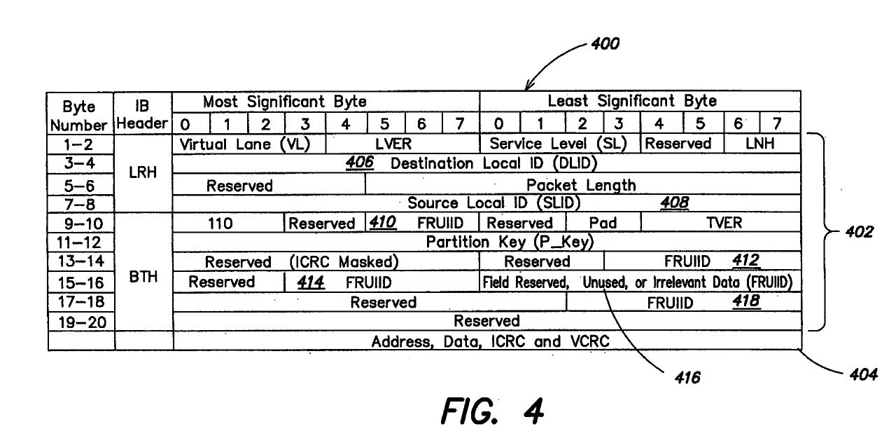

FIG. 4 is a block diagram of the structure of an exemplary data packet assembled using the Infiniband (IB) protocol. With reference to FIG. 4, the exemplary data packet 400 assembled using the IB protocol (“hereinafter exemplary IB packet”) may include header 402 and payload data 404. The header data 402 may be twenty bytes in size, the first eight bytes of which form a Local Route Header (LRH) and the last twelve bits of which form a Base Transport Header (BTH) (although a larger or smaller size may be employed for the LRH and/or BTH). As shown, the header data 402 may include data stored in a plurality of fields. However, only fields of the exemplary IB packet 400 that may be pertinent to the present methods and apparatus are described below. For example, the exemplary IB packet 400 may include a first field 406 adapted to store destination local ID (DLID) data and a second field 408 adapted to store source local ID (SLID) data. DLID data and SLID data may provide information about the destination and source, respectively, of the exemplary IB packet 400. Additionally, the exemplary IB packet 400 may include a plurality of fields that may be reserved, unused or may include irrelevant data (e.g., data not relevant to the exemplary IB packet 400). For example, the data packet 400 may include first through fifth fields 410-418 which are reserved, unused or include irrelevant data.

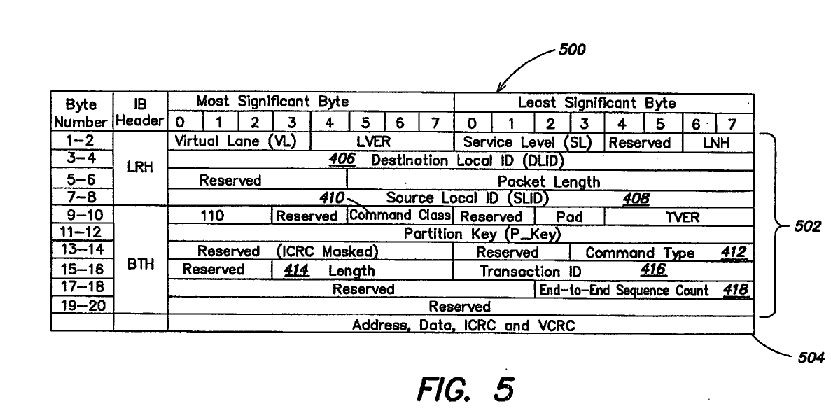

The present methods and apparatus may advantageously employ such fields 406-418 of the exemplary IB packet 400. More specifically, FIG. 5 is a block diagram of the structure of a non-Infiniband protocol data packet converted to an Infiniband protocol packet in accordance with an embodiment of the present invention. With reference to FIG. 5, when a non-IB packet 300 is converted to an IB packet in accordance with the present methods and apparatus, the resulting IB packet 500 may be similar to the exemplary IB packet 400 of FIG. 4. The resulting IB packet 500 may include header data 502 and payload data 504. However, in contrast to the DLID data of the exemplary IB packet 400 of FIG. 4, DLID data of the resulting IB packet 500 may be based on the destination ID data from the non-IB packet 300. For example, the destination ID data of the non-IB packet may be converted to corresponding information (e.g., DLID data) which may be understood by IB hardware and/or software of the computer system 100. Similarly, in contrast to the SLID data of the exemplary IB packet 400 of FIG. 4, SLID data of the resulting packet 500 may be based on the source ID data from the non-IB packet 300. For example, the source ID data of the non-IB packet may be converted to corresponding information (e.g., SLID data) which may be understood by IB hardware and/or software of the computer system 100. Additionally or alternatively, a first through fifth fields 410-418 of the resulting IB packet 500 may include updated versions of data (e.g., header data) from the non-IB packet 300. For example, command class data, command type data, length data, transaction ID data and end-to-end sequence count data from the non-IB packet 300 may be stored in the first through fifth fields 410-418, respectively, of the resulting IB packet 500. Alternatively, one or more of the command class data, command type data, length data, transaction ID data and/or end-to-end sequence count data from the non-IB packet 300 may be modified, and thereafter, stored in the first through fifth fields 410-418, respectively, of the resulting IB packet 500.

Further, an updated version of the payload data 304 of the non-IB packet 300 may be stored as the payload data 504 of the resulting IB packet 500. More specifically, the same or a modified version of the payload data 304 may be stored as the payload data 504 of the resulting IB packet 500.

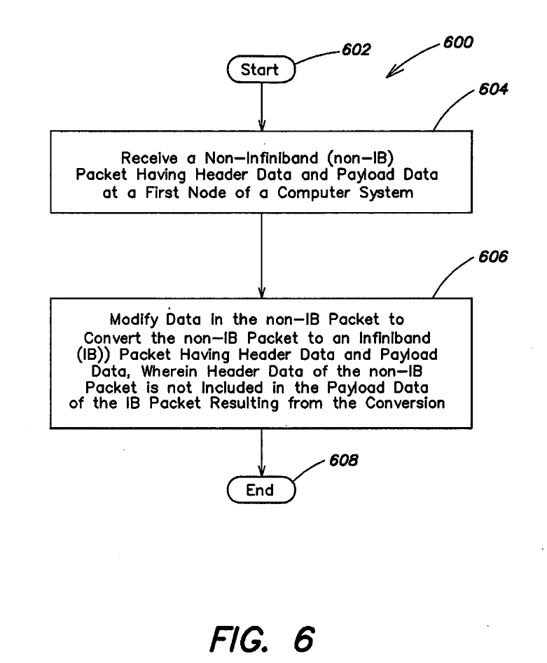

The operation of the system for transferring data is now described with reference to FIGS. 1-5 and with reference to FIG. 6 which illustrates an exemplary method of transferring data in accordance with an embodiment of the present invention. With reference to FIG. 6, in step 602, the method 600 begins. In step 604, a non-IB packet 300 having header data 302 and payload data 304 may be received at a first computer system node of a computer system 100. For example, the non-IB logic 124 included in and/or coupled to the non-IB device 114 of the first computer system node 102 may combine the data into a non-IB packet with the structure of the packet 300 of FIG. 3 and pass the non-IB packet to the IB logic 122. Alternatively, other nodes 102-108 of the system 100, such as the second and/or third computer system node 104, 106 may combine data into the non-IB packet 300 and pass the non-IB packet to the IB logic 122. Additionally or alternatively, other nodes 102-108 of the system 100 may receive non-IB packets and/or combine data into non-IB packets in a similar manner.

In step 606, data in the received non-IB packet may be modified to convert the non-IB packet 300 to an IB packet having header data and payload data, wherein header data of the non-IB packet 300 is not included in the payload data of the IB packet 500 resulting from the conversion. The conversion logic 126 (e.g., the first logic 127 of the conversion logic 126) may store an updated version of header data from the non-IB packet 300 in respective header data fields of a resulting IB packet 500, which may be an IB Unreliable Datagram. More specifically, the conversion logic 126 may store the same or a modified version of the header data from the non-IB packet 300 in header data fields of the resulting IB packet 500. For example, the conversion logic 126 may modify the destination ID data of the non-IB packet 300 into DLID data of the resulting IB packet 500. IB firmware may understand the DLID data. Further, the DLID data may serve the same purpose for the resulting IB packet 500 as the destination ID data for a non-IB packet 300. Therefore, the DLID data of the resulting IB packet 500 may serve as a mapped version of the destination ID data of the non-IB packet 300. The conversion logic 126 may modify the source ID data of the non-IB packet 300 into SLID data of the resulting IB packet 500 in a similar manner.

In some embodiments, a functional or protocol layer of the IB protocol may provide the DLID data and/or SLID data of the resulting-IB packet 500, and therefore, the conversion logic 126 may not store an updated version of such data in corresponding fields of the resulting IB packet 500 during conversion.

Additionally or alternatively, the conversion logic 126 may employ the command class, command type, length, transaction ID and end-to-end sequence count data of the non-IB packet 300 to populate respective fields 410-418 of the resulting IB packet 500. For example, the conversion logic 126 may copy the command class, command type, length, transaction ID and end-to-end sequence count data of the non-IB packet 300 and write such data to the first through fifth fields 410-418, respectively, of the resulting IB packet 500. Because the conversion logic 126 is not required to modify but may merely copy data from the non-IB packet 300 to the resulting IB packet 500 during conversion, the conversion may introduce little or no latency. It should be noted that, in some embodiments, only IB header data fields employed by end nodes (e.g., nodes 102-108) may be redefined.

The conversion logic 126 may not employ some data of the non-IB packet 300 during conversion. For example, the link sequence count data of the non-IB packet 300 may have been previously employed by a non-IB layer of function, such as a non-IB link layer and/or IB flow control packets may now manage corresponding functions. Therefore, the conversion logic 126 may not map the link sequence count data of the non-IB packet 300 to the resulting IB packet 500. In this manner, the conversion logic 126 may deconstruct the header of the non-IB (e.g., legacy) packet and use IB packet header data fields (e.g., existing and/or reserved BTH fields) to construct an IB header. Consequently, the non-IB header may be included in an IB header. By redefining the header of an IB packet as described above, overhead incurred by translating the non-IB packet to an IB packet may be limited to the differential between the non-IB packet header length and the IB packet header length.

In a similar manner, the conversion logic 126 may store an updated (e.g., the same or a modified) version of the payload data 304 from the non-IB packet 300 in one or more payload data fields of the resulting IB packet 500. For example, the conversion logic 126 may employ the payload data 304 of the non-IB packet 300 as the payload data 504 of the resulting IB packet 500. However, after the conversion logic 126 converts the non-IB packet 300 to an IB packet 500 as described above, according to the IB protocol, a lower protocol layer (e.g., the IB link layer 206) may modify the payload data 504 to include error checking data (e.g., Invariant Cyclic Redundancy Check (ICRC) and/or Variant Cyclic Redundancy Check (VCRC)). The ICRC and/or VCRC may be generated by sending logic and checked by receiving logic to make sure a packet has not been corrupted as the packet traverses a network. Such error checking data enables the resulting IB packet 500 to be less error prone during transmission on noisy communication links.

Because the conversion logic 126 stores header data from the non-IB packet 300 to existing header data fields (e.g., which previously were reserved, unused or included irrelevant data) of the resulting IB packet 500 during conversion, the conversion may require little or no overhead. In this manner, header data 302 from the non-IB packet 300 may be included in header data 502 of the resulting IB packet 500. Consequently, payload data 504 of the resulting IB packet 500 is not required to store such header data.

Thereafter, step 608 may be performed. In step 608, the method 600 ends.

Additionally, the IB packet 500 resulting from conversion may be transferred between the first computer system node and a second computer system node using the IB protocol. For example, the resulting IB packet 500 may be transferred from the first computer system node 102 to the second computer system node 104 via the IB network 110. Fields of the resulting IB packet header data 502 employed and/or modified by the IB network 110 (e.g., one or more switches 112 of the IB network 110) may maintain their IB-defined purpose during conversion. In this manner, the present methods and apparatus may ensure the IB packet 500 resulting from conversion is compatible with the IB network 110.

A second node of the computer system 100 may receive an IB packet 500 and determine the IB packet 500 is a non-IB packet 300 that was converted to the IB packet. The second computer system node 104 may make such determination based on the header data 502 of the received IB packet 500. As stated, some of the header data 502 was stored in respective header data fields (e.g., 410-418) of the received IB packet 500 while modifying data in the non-IB packet 300 in another computer system node (e.g., the first computer system node 102) to convert the non-IB packet 300 to an IB packet 500 having header data and payload data. More specifically, the second computer system node 104 may determine the received packet 500 is a non-IB packet 300 that was converted to the IB packet 500 based on manufacturer specific opcode (MSO) of the received packet 500. As stated, command class data and command type data may serve to identify the MSO of the received packet 500.

When the second node 104 of the computer system 100 determines an IB packet 500 received at the second computer system node 104 is a non-IB packet 300 that was converted to the IB packet 500, the header and payload data 502, 504 of the IB packet 500 may be employed to create a non-IB packet with the structure of the packet 300 of FIG. 3 at the second computer system node 104. More specifically, the received packet 500 may be provided (e.g., routed) to conversion logic 126 (e.g., second logic 127 of the conversion logic 126) of the second node 104. Such logic may modify data in the received IB packet 500 to convert the received IB packet 500 to a non-IB packet 300 having header data and payload data. More specifically, the conversion logic 126 may employ an updated version of the IB packet header data 502 to create the header data 302 of a non-IB packet at the second computer system node 104. For example, the conversion logic 126 (e.g., the second logic 128 of the conversion logic 126) may store an updated (e.g., the same or a modified) version of header data 502 from the received IB packet 500 in respective header data fields of the non-IB packet 300 at the second computer system node 104. The conversion logic 126 may modify the DLID data of the received IB packet 500 into destination ID data of the resulting non-IB packet 300. Further, the conversion logic 126 may modify the SLID data of the received IB packet 500 into source ID data of the resulting non-IB packet 300 in a similar manner.

Additionally or alternatively, the conversion logic 126 may employ the command class, command type, length, transaction ID and end-to-end sequence count data of the received IB packet 500 to populate respective fields of the resulting non-IB packet 300 at the second computer system node 104. For example, the conversion logic 126 may copy the command class, command type, length, transaction ID and end-to-end sequence count data of the received IB packet 500 and write such data to the resulting non-IB packet 300. Because the conversion logic 126 is not required to modify but may merely copy data from the received IB packet 500 to the non-IB packet 300 during conversion, the conversion introduces little or no latency. In this manner, the conversion logic 126 may form header data 302 of the non-IB packet 300 at the second computer system node 104. More specifically, the conversion logic 126 may take apart (e.g., strip off) the header of the received IB packet and employ such header to rebuild (e.g., reassemble) a non-IB (e.g., legacy) header based on the non-IB protocol.

In a similar manner, the conversion logic 126 may store an updated version of the payload data 504 from the received IB packet 500 in one or more payload data fields of the resulting non-IB packet 300. For example, the conversion logic 126 may employ the same or a modified version of the payload data 504 of the received IB packet 500 as the payload data 304 of the resulting non-IB packet 300.

Further, the header data 302 of the non-IB packet 300 at the second computer system node 104 may be combined with the updated version of the payload data of the received IB packet 500 to create (e.g., assemble) the non-IB packet 300 at the second computer system node 104, thereby converting the received IB packet 500 to the non-IB packet 300 at the second computer system node 104.

The non-IB packet 300 resulting from the conversion may be provided (e.g., forwarded) to a non-IB device 114 of the second computer system node 104 or elsewhere (e.g., another node) for processing. The non-IB device 114 may be an existing non-IB device (e.g., legacy device). In this manner, the present methods and apparatus may enable non-IB data to be transferred between nodes 102-108 of a computer system 100 using an IB network 110. Consequently, the present methods and apparatus enable existing non-IB hardware of a computer system to employ faster technology such as IB hardware and/or software without requiring significant hardware and/or software changes to the system.

Through use of the present methods and apparatus, non-IB logic and software (e.g., legacy non-IB logic and software) may coexist and interoperate with IB logic and software in a computer system and are thereby maintained. The logic may provide a mechanism for bridging between a non-IB protocol and the IB protocol. For example, such logic in a first node of the computer system may convert a non-IB data packet to an IB data packet with reduced overhead and/or latency. Further, the IB packet may be transmitted between the first node and a second node of the computer system. Similar logic at the second node 104 of the computer system may convert an IB packet received at the second node to a non-IB packet, such that the non-IB packet may be processed by a non-IB device 104 of the second node 104. In this manner, the present invention provides methods and apparatus for transparently transferring non-IB (e.g., legacy) protocol packets across an IB network. Because packet overhead is reduced, the packet transfer may efficiently use bandwidth. Further, any latency of such transfer may be reduced.

The foregoing description discloses only exemplary embodiments of the invention. Modifications of the above disclosed apparatus and methods which fall within the scope of the invention will be readily apparent to those of ordinary skill in the art. For instance, although a data transfer from the first node 102 to the second node 104 of the computer system 100 is described above, in other embodiments, data may be transferred from another node 102-108 and/or to another node 102-108 of the computer system 100. In embodiments described above, specific non-IB packet header data is updated to form the IB packet header data, and vice versa. However, in other embodiments, a larger or smaller amount of data and/or different data may be updated to form the IB packet header data, and vice versa. Further, although conversion of RIO protocol packets to IB packets is described above, the present methods and apparatus are not limited to such conversion. The present methods and apparatus may be used to maintain and transfer any packet-based protocol across an IB network. Although the present methods and apparatus may be employed to maintain legacy I/O hardware and software, the present methods and apparatus may bridge other protocols into an IB network and then back to the original protocol while introducing minimal overhead and/or latency, if any. Additionally, use of the present methods and apparatus (e.g., by others) may be detected. For example, assume the present methods and apparatus are employed to attach legacy I/O hardware and software to an IB network. Once the legacy device type being used is known, a protocol analyzer or similar device may be employed to monitor one or more portions of the computer system (e.g., an IB link) and examine the header structure of monitored packets (e.g., to detect differences from a typical IB packet structure).

Accordingly, while the present invention has been disclosed in connection with exemplary embodiments thereof, it should be understood that other embodiments may fall within the spirit and scope of the invention, as defined by the following claims.

The invention claimed is:

1. A method of transferring data using an Infiniband (IB) protocol, comprising:
receiving a non-IB packet having header data and payload data at a first node of a computer system; and
modifying data in the non-IB packet to convert the non-IB packet to an IB packet having header data and payload data, wherein header data of the non-IB packet is not included in the payload data of the IB packet resulting from the conversion.

2. The method of claim 1 wherein modifying data in the non-IB packet to convert the non-IB packet to an IB packet having header data and payload data includes:
storing an updated version of header data from the non-IB packet in respective header data fields of the IB packet; and
storing an updated version of payload data from the non-IB packet as payload data of the IB packet.

3. The method of claim 2 wherein:
an updated version of the header data includes the same or a modified version of the header data; and
an updated version of the payload data includes the same or a modified version of the payload data.

4. The method of claim 1 further comprising transferring the IB packet between the first computer system node and a second computer system node using the IB protocol.

5. The method of claim 4 further comprising:
determining an IB packet received at the second computer system node is a non-IB packet that was converted to the IB packet; and
employing the header and payload data of the IB packet to create a non-IB packet at the second computer system node.

6. The method of claim 5 wherein determining the IB packet received at the second computer system node is a non-IB packet that was converted to the IB packet includes determining the IB packet received at the second computer system node is a non-IB packet that was converted to the IB packet based on header data of the IB packet, wherein the header data was stored in respective header data fields of the IB packet while modifying data in the non-IB packet in the another computer system node to convert the non-IB packet to an IB packet having header data and payload data.

7. The method of claim 5 wherein employing the header and payload data of the IB packet to create the non-IB packet at the second computer system node includes:
employing an updated version of the IB packet header data to create the header data of the non-IB packet at the second computer system node; and
combining the header data of the non-IB packet at the second computer system node with an updated version of the IB packet payload data to create the non-IB packet at the second computer system node, thereby converting the IB-packet to the non-IB packet at the second computer system node.

8. The method of claim 7 wherein:
an updated version of the IB packet header data includes the same or a modified version of the IB packet header data; and
an updated version of the IB packet payload data includes the same or a modified version of the IB packet payload data.

9. An apparatus for transferring data using an Infiniband (IB) protocol, comprising:
a first computer system node having:
IB logic adapted to execute IB software and transfer data as IB packets; and
first logic, coupled to the IB logic, and adapted to:
receive a first non-IB packet having header data and payload data; and
modify data in the first non-IB packet to convert the first non-IB packet to an IB packet having header data and payload data, wherein header data of the first non-IB packet is not included in the payload data of the IB packet resulting from the conversion.

10. The apparatus of claim 9 wherein the first logic is further adapted to:
store an updated version of header data from the first non-IB packet in respective header data fields of the IB packet; and
store an updated version of the payload data from the first non-IB packet as payload data of the IB packet.

11. The apparatus of claim 10 wherein:
an updated version of the header data includes the same or a modified version of the header data; and
an updated version of the payload data includes the same or a modified version of the payload data.

12. The apparatus of claim 9 wherein the first computer system node is adapted to transfer the IB packet between the first computer system node and a second computer system node using the IB protocol.

13. The apparatus of claim 12 wherein the first computer system node is further adapted to:
determine an IB packet received by the first computer system node is a second non-IB packet that was converted to the IB packet; and
employ the header and payload data of the received IB packet to create a third non-IB packet at the first computer system node.

14. The apparatus of claim 13 wherein the first computer system node is further adapted to determine the received IB packet is a second non-IB packet that was converted to the received IB packet based on header data of the received IB packet, wherein the header data was stored in respective header data fields of the received IB packet while modifying data in the second non-IB packet in another node of the computer system to convert the second non-IB packet to the received IB packet having header data and payload data.

15. The apparatus of claim 13 wherein the first computer system node is further adapted to:
employ an updated version of the header data of the received IB packet to create the header data of the third non-IB packet at the first computer system node; and
combine the header data of the third non-IB packet at the first computer system node with an updated version of the payload data of the received IB packet to create the third non-IB packet at the first computer system node, thereby converting the received IB packet to the third non-IB packet at the first computer system node.

16. The apparatus of claim 15 wherein:
an updated version of the header data of the received IB packet includes the same or a modified version of the header data of the received IB packet; and
an updated version of the payload data of the received IB packet includes the same or a modified version of the payload data of the received IB packet.

17. A system for transferring data using an Infiniband (IB) protocol, comprising:
a first computer system node having:
IB logic adapted to execute IB software and transfer data as IB packets, and
first logic, coupled to the IB logic, and adapted to:
receive a non-IB packet having header data and payload data, and
modify data in the non-IB packet to convert the non-IB packet to an IB packet having header data and payload data, wherein header data of the non-IB packet is not included in the payload data of the IB packet resulting from the conversion;
a second computer system node; and
an IB network coupling the first computer system node to the second computer system node.

18. The system of claim 17 wherein the first logic is further adapted to:
store an updated version of header data from the non-IB packet in respective header data fields of the IB packet; and
store an updated version of the payload data from the non-IB packet as payload data of the IB packet.

19. The system of claim 18 wherein:
an updated version of the header data includes the same or a modified version of the header data; and
an updated version of the payload data includes the same or a modified version of the payload data.

20. The system of claim 17 wherein the first computer system node is adapted to transfer the IB packet between the first computer system node and the second computer system node using the IB protocol via the IB network, wherein the second computer system node includes:
IB logic adapted to execute IB software and transfer data as IB packets; and
second logic, coupled to the IB logic, and adapted to:
determine an IB packet received at the second computer system node is a non-IB packet that was converted to the received IB packet,
employ the header and payload data of the received IB packet to create a non-IB packet at the second computer system node,
employ an updated version of the header data of the received IB packet to create the header data of the non-IB packet at the second computer system node, and
combine the header data of the non-IB packet at the second computer system node with an updated version of the payload data of the received IB packet to create the non-IB packet at the second computer system node, thereby converting the received IB-packet to the non-IB packet at the second computer system node,
wherein an updated version of the IB packet header data includes the same or a modified version of the IB packet header data, and
wherein an updated version of the IB packet payload data includes the same or a modified version of the IB packet payload data.
